(19) United States
(12) Patent Application Publication
(10) Pub. No.: US 2026/0279314 A1
(43) Pub. Date: Sep. 17, 2026

(54) REPAIR STAND FOR STRINGED INSTRUMENTS

(71) Applicant: Nicole Burchell, Petawawa (CA)

(72) Inventor: Nicole Burchell, Petawawa (CA)

(21) Appl. No.: 19/081,590

(22) Filed: Mar. 17, 2025

(51) Int. Cl. G10G 5/00; B25H 1/00; F16M 11/20

(52) U.S. Cl. CPC G10G 5/00; B25H 1/0035; F16M 11/2092

(57) ABSTRACT

A repair stand for stringed instruments includes a first panel, a second panel, a support frame, and a receptacle. The second panel is positioned parallel to the first panel. The support frame is positioned between and connecting the first panel and the second panel. The support frame is selectively adjustable to adjust the distance between the first panel and the second panel. The support frame is designed to support a body of a stringed instrument thereon in a horizontal position with strings of the stringed instrument facing upwardly and a neck portion of the stringed instrument resting on the first panel. The receptacle is positioned in the second panel. The receptacle is designed to receive and hold a strap button of the stringed instrument.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to repair devices for musical instruments and more particularly pertains to a new repair stand for supporting a stringed instrument in a horizontal position with strings of the stringed instrument facing upwardly. Often stringed instruments require replacement or repair of the strings and related components. Usually a user holds the stringed instrument on his or her lap. However, it can be difficult to both hold the stringed instrument steady and simultaneously replace or repair the strings. The new repair stand holds the stringed instrument securely, thereby freeing up the hands of the user to execute the repair.

### (2) Description of Related Art Including Information Disclosed Under 37 CFR 1.97 and 1.98

The prior art relates to repair devices for musical instruments. The prior art, as best understood, does not disclose a repair stand for stringed instruments that includes a first panel, a second panel, a support frame, and a receptacle, wherein the second panel is positioned parallel to the first panel and the support frame is positioned between and connecting the first panel and the second panel. The support frame is designed to support a body of a stringed instrument thereon in a horizontal position with strings of the stringed instrument facing upwardly and a neck portion of the stringed instrument resting on the first panel. The receptacle is positioned in the second panel and is designed to receive and hold a strap button of the stringed instrument.

### BRIEF SUMMARY OF THE INVENTION

An embodiment of the disclosure meets the needs presented above in a repair stand generally comprising a first panel, a second panel, a support frame, and a receptacle. The second panel is positioned parallel to the first panel. The support frame is positioned between and connecting the first panel and the second panel. The support frame is selectively adjustable to adjust the distance between the first panel and the second panel. The support frame is designed to support a body of a stringed instrument thereon in a horizontal position with strings of the stringed instrument facing upwardly and a neck portion of the stringed instrument resting on the first panel. The receptacle is positioned in the second panel. The receptacle is designed to receive and hold a strap button of the stringed instrument.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a repair stand according to an embodiment of the disclosure.

FIG. 2 is a rear view of an embodiment of the disclosure in use.

FIG. 3 is a left side view of an embodiment of the disclosure.

FIG. 4 is a right side view of an embodiment of the disclosure.

FIG. 5 is a top view of an embodiment of the disclosure.

FIG. 6 is a bottom view of an embodiment of the disclosure.

FIG. 7 is a perspective view of an embodiment of the disclosure.

FIG. 8 is a close-up view of a component of an embodiment of the disclosure.

### DETAILED DESCRIPTION OF THE INVENTION

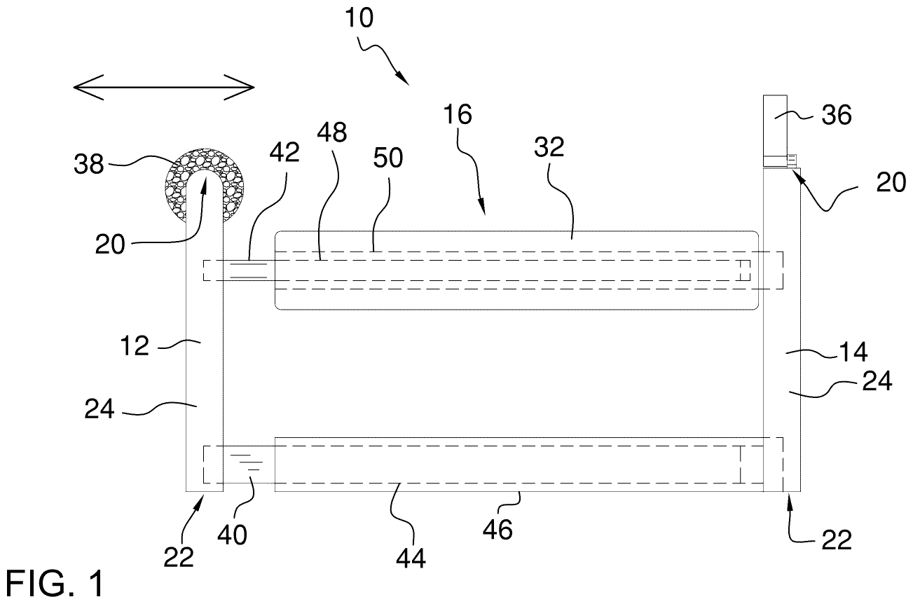

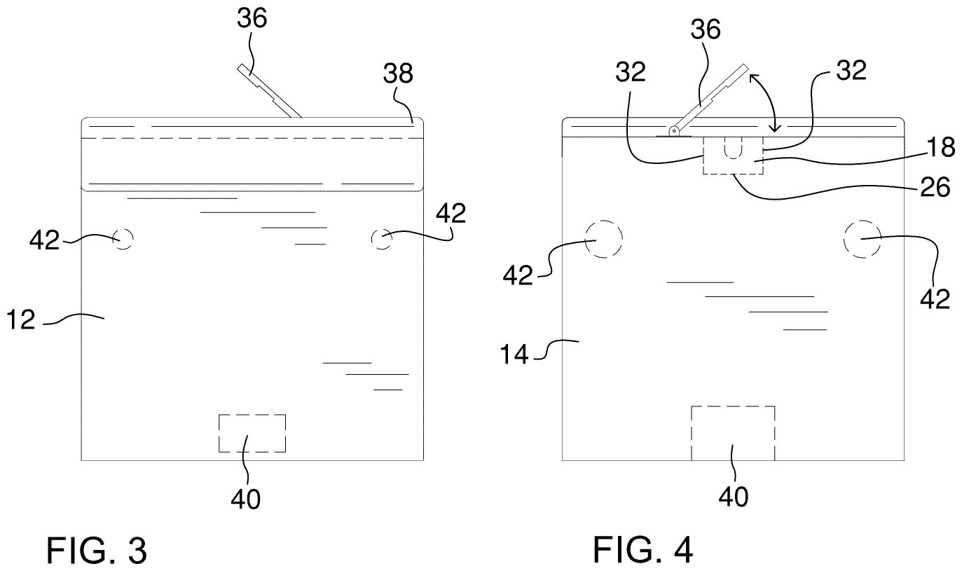

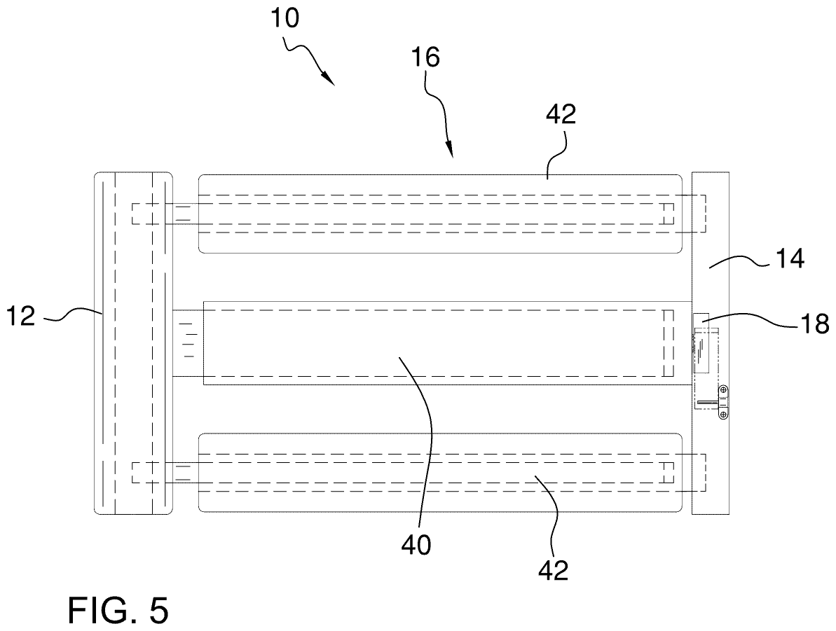

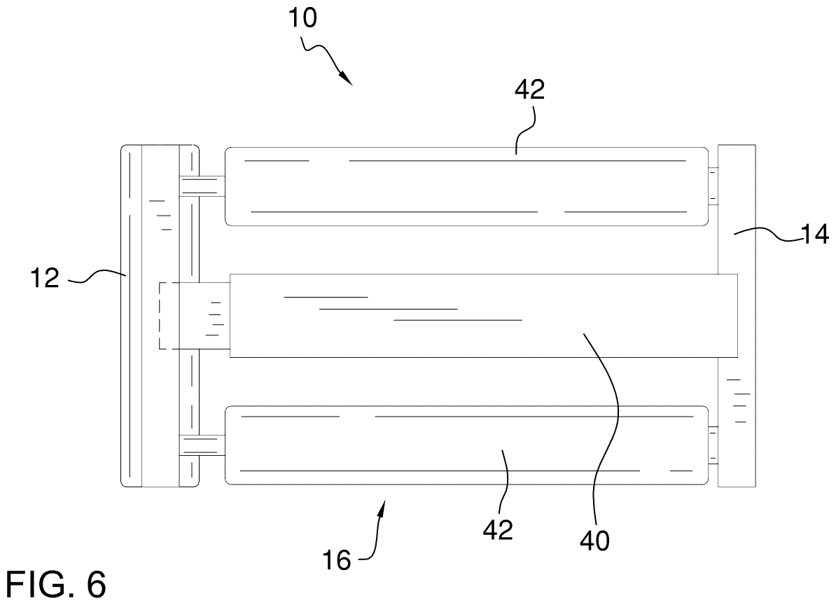

With reference now to the drawings, and in particular to FIGS. 1 through 8 thereof, a new repair stand embodying the principles and concepts of an embodiment of the disclosure and generally designated by the reference numeral 10 will be described.

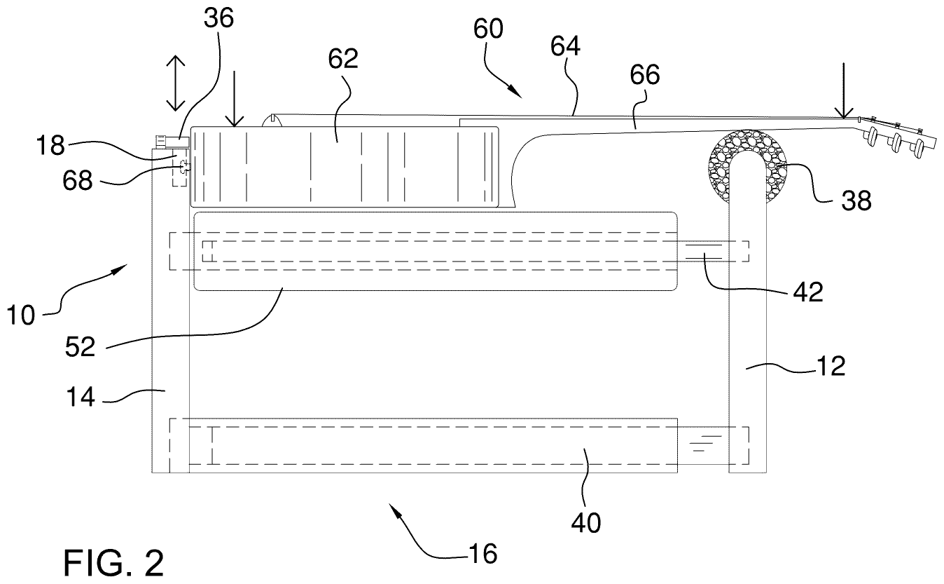

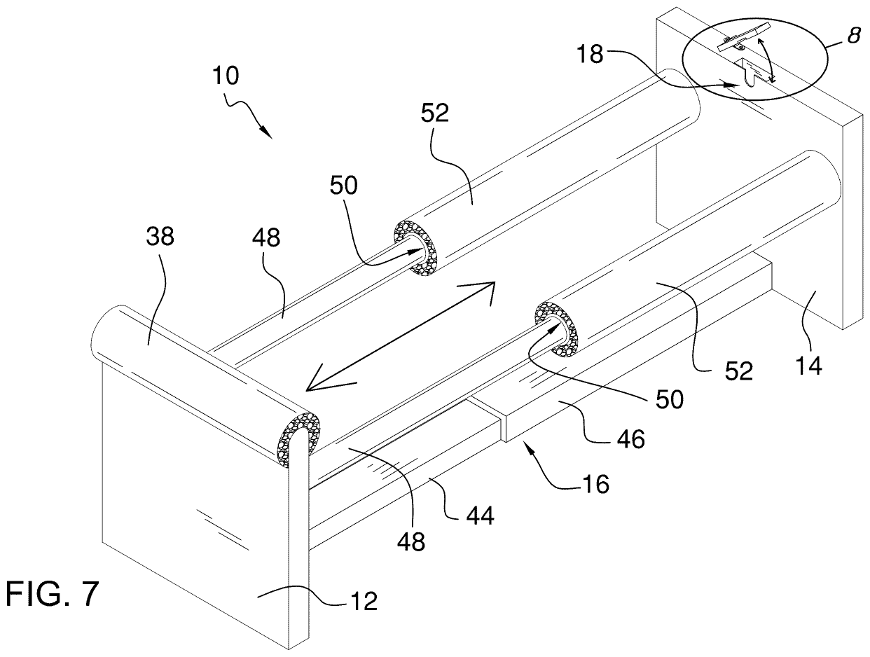

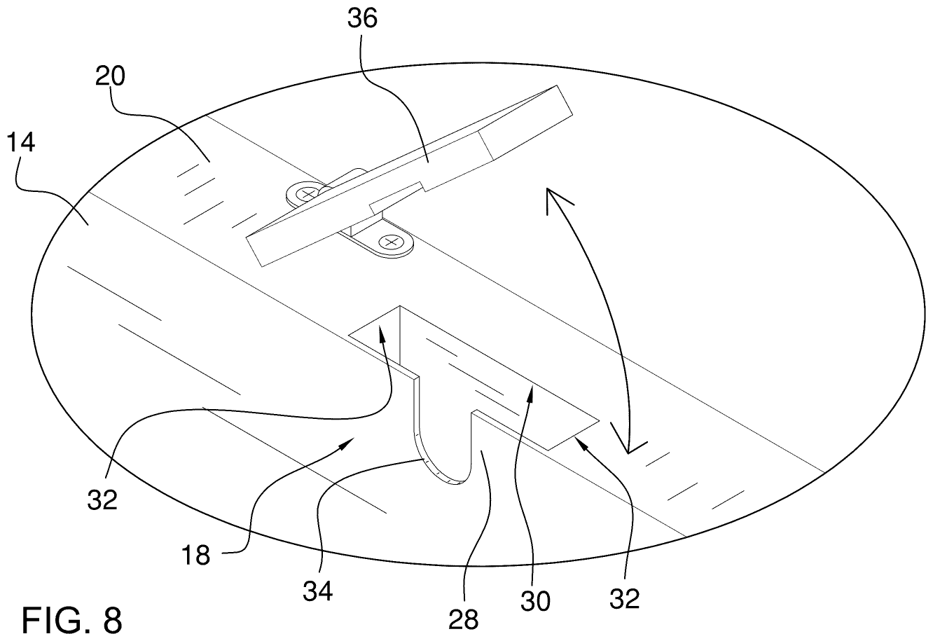

As best illustrated in FIGS. 1 through 8, the repair stand 10 generally comprises a first panel 12, a second panel 14, a support frame 16, and a receptacle 18. As shown in FIG. 1, the second panel 14 is positioned parallel to the first panel 12. The support frame 16 is positioned between and connecting the first panel 12 and the second panel 14. As shown in FIG. 7, the support frame 16 is selectively adjustable to adjust the distance between the first panel 12 and the second panel 14. As shown in FIG. 2, the support frame 16 is designed to support a body 62 of a stringed instrument 60 thereon in a horizontal position with strings 64 of the stringed instrument 60 facing upwardly and a neck 66 of the stringed instrument 60 resting on the first panel 12. As shown in FIGS. 7 and 8, the receptacle 18 is positioned in the second panel 14. The receptacle 18 is designed to receive and hold a strap button 68 of the stringed instrument 60.

Each of the first panel 12 and the second panel 14 has a top edge 20, a bottom edge 22, and a pair of lateral edges 24. In the exemplary embodiment in FIGS. 7 and 8, the receptacle 18 is positioned at the top edge 20. The receptacle 18 includes a bottom wall 26, a front wall 28, a rear wall 30, and two side walls 32. The receptacle 18 includes a groove 34 in the front wall 28 designed to receive a narrower central portion of the strap button 68, such that a flared end portion of the strap button 68 is retained against axial movement out of the receptacle 18 by the front wall 28.

In the exemplary embodiment in FIGS. 7 and 8, the repair stand 10 further includes a cover 36. The cover 36 is pivotably coupled to the top edge 20 of the second panel 14. The cover 36 is pivotable over the receptacle 18 to close the receptacle 18 when the strap button 68 is in the receptacle 18. In another possible embodiment, the cover 36 could be omitted. In the exemplary embodiment, the cover 36 is connected by a hinge, though in another possible embodiment the cover 36 could have a different design, such as a slidable piece or a snap-fit structure.

As shown in FIG. 1, the repair stand 10 also includes a cushion 38. The cushion 38 is coupled to the first panel 12. The cushion 38 is positioned over the top edge 20 of the first panel 12 to support the neck 66 of the stringed instrument 60, as shown in FIG. 2. The cushion 38 could be made of foam or other suitable material, such as soft synthetic or natural fibers.

In the exemplary embodiment in FIG. 7, the support frame 16 includes a bar 40 and a pair of rods 42. The bar 40 has a first end coupled to the first panel 12 and a second end coupled to the second panel 14. The bar 40 is positioned to extend perpendicularly from the first panel 12 and the second panel 14. The bar 40 is selectively adjustable in length. Each of the rods 42 is coupled to the first panel 12 and the second panel 14. Each of the rods 42 is selectively adjustable in length. The rods 42 are designed to support the body 62 of the stringed instrument 60 thereon.

The bar 40 is positioned adjacent the bottom edge 22 of each of the first panel 12 and the second panel 14. The bar 40 includes a first bar section 44 coupled to the first panel 12 and a second bar section 46 coupled to the second panel 14. The first bar section 44 and the second bar section 46 are positioned in a telescoping manner, and could be locked in a desired position in a manner well known in the mechanical arts, such as by friction engagement or spring-loaded pins. The first bar section 44 and the second bar section 46 could also be adjustable by interlocking pieces connectable at different positions.

Each of the rods 42 is positioned adjacent the top edge 20 of each of the first panel 12 and the second panel 14. Each of the rods 42 is positioned parallel to one another adjacent a respective one of the lateral edges 24 of each of the first panel 12 and the second panel 14. Each of the rods 42 includes a first rod section 48 coupled to the first panel 12 and a second rod section 50 coupled to the second panel 14. The first rod section 48 and the second rod section 50 are positioned in a telescoping manner, similar to the first bar section 44 and the second bar section 46. In another possible embodiment, the rods 42 could be vertically adjustable. For example, the first panel 12 and the second panel 14 could have slots or multiple openings in which the rods 42 could be mounted in a vertically-adjustable manner.

The repair stand 10 further includes a pair of padded sleeves 52. Each of the padded sleeves 52 is coupled to a respective one of the rods 42 to support the body 62 of the stringed instrument 60. The padded sleeves 52 could be made of foam or another suitable material, similar to the cushion 38.

FIG. 2 shows an example of the repair stand 10 in use supporting the stringed instrument 60, specifically a guitar. The user places the strap button 68 into the receptacle 18. The user can then pivot the cover 36 over the receptacle 18 to effectively lock the strap button 68 in place. The body 62 of the stringed instrument 60 is supported on the rods 42. The neck 66 of the stringed instrument 60 is placed on the cushion 38 on the first panel 12. The user can adjust the length of the support frame 16 as needed or desired to accommodate the stringed instrument 60. The user now has both hands free to perform repair tasks, such as replacing one or more strings 64.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A repair stand for stringed instruments comprising:
a first panel;
a second panel, said second panel being positioned parallel to said first panel;
a support frame, said support frame being positioned between and connecting said first panel and said second panel, said support frame being selectively adjustable to adjust the distance between said first panel and said second panel, said support frame being configured to support a body of a stringed instrument thereon in a horizontal position with strings of the stringed instrument facing upwardly and a neck of the stringed instrument resting on said first panel; and
a receptacle, said receptacle being positioned in said second panel, said receptacle being configured to receive and hold a strap button of the stringed instrument.

2. The repair stand of claim 1, wherein:
each of said first panel and said second panel has a top edge, a bottom edge, and a pair of lateral edges; and
said receptacle is positioned at said top edge.

3. The repair stand of claim 1, wherein:
said receptacle includes a bottom wall, a front wall, a rear wall, and two side walls; and
said receptacle includes a groove in said front wall configured to receive a narrower central portion of the strap button, such that a flared end portion of the strap button is retained against axial movement out of said receptacle by said front wall.

4. The repair stand of claim 2, further comprising a cover, said cover being pivotably coupled to said top edge of said second panel, said cover being pivotable over said receptacle to close said receptacle when the strap button is in said receptacle.

5. The repair stand of claim 2, further comprising a cushion, said cushion being coupled to said first panel, said cushion being positioned over said top edge of said first panel to support the neck of the stringed instrument.

6. The repair stand of claim 1, wherein:
said support frame includes a bar and a pair of rods;
said bar has a first end coupled to said first panel and a second end coupled to said second panel;
said bar is positioned to extend perpendicularly from said first panel and said second panel;
said bar is selectively adjustable in length;
each of said rods is coupled to said first panel and said second panel;
each of said rods is selectively adjustable in length; and
said rods are configured to support the body of the stringed instrument thereon.

7. The repair stand of claim 2, wherein:
said support frame includes a bar and a pair of rods;
said bar has a first end coupled to said first panel and a second end coupled to said second panel;
said bar is positioned to extend perpendicularly from said first panel and said second panel;
said bar is selectively adjustable in length;
each of said rods is coupled to said first panel and said second panel;
each of said rods is selectively adjustable in length; and
said rods are configured to support the body of the stringed instrument thereon.

8. The repair stand of claim 7, wherein said bar is positioned adjacent said bottom edge of each of said first panel and said second panel.

9. The repair stand of claim 7, wherein:
said bar includes a first bar section coupled to said first panel and a second bar section coupled to said second panel; and
said first bar section and said second bar section are positioned in a telescoping manner.

10. The repair stand of claim 7, wherein:
each of said rods is positioned adjacent said top edge of each of said first panel and said second panel; and
each of said rods is positioned parallel to one another adjacent a respective one of said lateral edges of each of said first panel and said second panel.

11. The repair stand of claim 7, wherein:
each of said rods includes a first rod section coupled to said first panel and a second rod section coupled to said second panel; and
said first rod section and said second rod section are positioned in a telescoping manner.

12. The repair stand of claim 7, further comprising a pair of padded sleeves, each of said padded sleeves being coupled to a respective one of said rods to support the body of the stringed instrument.

13. The repair stand of claim 2, wherein:
said receptacle includes a bottom wall, a front wall, a rear wall, and two side walls; and
said receptacle includes a groove in said front wall configured to receive a narrower central portion of the strap button, such that a flared end portion of the strap button is retained against axial movement out of said receptacle by said front wall.

14. The repair stand of claim 13, further comprising a cover, said cover being pivotably coupled to said top edge of said second panel, said cover being pivotable over said receptacle to close said receptacle when the strap button is in said receptacle.

15. The repair stand of claim 14, further comprising a cushion, said cushion being coupled to said first panel, said cushion being positioned over said top edge of said first panel to support the neck of the stringed instrument.

16. The repair stand of claim 15, wherein:
said support frame includes a bar and a pair of rods;
said bar has a first end coupled to said first panel and a second end coupled to said second panel;
said bar is positioned to extend perpendicularly from said first panel and said second panel;
said bar is selectively adjustable in length;
each of said rods is coupled to said first panel and said second panel;
each of said rods is selectively adjustable in length; and
said rods are configured to support the body of the stringed instrument thereon.

17. The repair stand of claim 16, wherein:
said bar is positioned adjacent said bottom edge of each of said first panel and said second panel;
said bar includes a first bar section coupled to said first panel and a second bar section coupled to said second panel; and
said first bar section and said second bar section are positioned in a telescoping manner.

18. The repair stand of claim 17, wherein:
each of said rods is positioned adjacent said top edge of each of said first panel and said second panel; and
each of said rods is positioned parallel to one another adjacent a respective one of said lateral edges of each of said first panel and said second panel.

19. The repair stand of claim 18, wherein:
each of said rods includes a first rod section coupled to said first panel and a second rod section coupled to said second panel; and
said first rod section and said second rod section are positioned in a telescoping manner.

20. The repair stand of claim 19, further comprising a pair of padded sleeves, each of said padded sleeves being coupled to a respective one of said rods to support the body of the stringed instrument.
